(19) United States
(12) Patent Application Publication
(10) Pub. No.: US 2022/0294605 A1
(43) Pub. Date: Sep. 15, 2022

(54) BLOCKCHAIN-BASED PUBLIC PARAMETER GENERATION METHOD AGAINST BACKDOOR ATTACKS

(71) Applicants: University of Electronic Science and Technology of China, Chengdu (CN); Yangtze Delta Region Institute (Huzhou), University of Electronic Science and Technology of China, Huzhou (CN)

(72) Inventors: Chunxiang XU, Chengdu (CN); Changsong JIANG, Chengdu (CN); Yicong DU, Chengdu (CN)

(21) Appl. No.: 17/517,661

(22) Filed: Nov. 2, 2021

(30) Foreign Application Priority Data
Mar. 9, 2021 (CN) 202110256955.3

(51) Int. Cl. H04L 9/00; H04L 9/06

(52) U.S. Cl. CPC H04L 9/002; H04L 9/0643; H04L 2209/38

(57) ABSTRACT

A blockchain-based public parameter generation method against backdoor attacks, includes: acquiring the hash values of L latest confirmed blocks on a blockchain, and the hash values of the L blocks and a count variable for generation are mapped to an element in a set G via a specified mapping to obtain the generated public parameter; L≥φ, φ is the minimum number to guarantee blockchains' chain quality property; checking whether the generated parameter meets the condition, if not, discarding the parameter and updating the generated public parameter; if the condition is met, outputting the public parameter to the device that uses the public parameter. In this disclosure, the public parameters are random, since they are based on the latest confirmed blocks on the blockchain and are guaranteed by the computational power of the blockchain; the generation of public parameters is publicly verifiable and random.

### CROSS-REFERENCE TO RELATED APPLICATIONS

Pursuant to 35 U.S.C. § 119 and the Paris Convention Treaty, this application claims foreign priority to Chinese Patent Application No. 202110256955.3 filed Mar. 9, 2021, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND

The disclosure relates to blockchain technology, and more particularly to a public parameter generation method against backdoor attacks.

Cryptographic devices are often used in the form of black boxes, where device users trust that the implementation of the cryptographic device agrees with the security specification and would not check the authenticity of codes in the device. Users employ the device to generate public parameters and secret keys. However, in a black-box environment, attackers (e.g., manufacturer) may secretly embed a trapdoor into a cryptographic device: the user's secret key is embedded into public parameters, such as the attacker leverages her/his public key to encrypt the user's secret key to generate the public parameter. The parameter is indistinguishable from the public parameter generated by a publicly known cryptographic algorithm. An attacker owning the backdoor can easily recover the secret key from the public parameter in an unnoticeable fashion (e.g., decrypting the public parameter by the attacker's private key to recover the secret key). Accordingly, the security of the cryptographic algorithm is compromised. Such an attack is referred to as backdoor attacks.

On the other hand, the blockchain is a new application mode of computer technology such as distributed data storage, peer-to-peer transfer, consensus mechanism, and encryption algorithm. Specifically, the blockchain is composed of nodes based on peer-to-peer networks, and each node maintains the consistency of the data by executing the consensus mechanism. The blockchain uses the hash of the block to connect the blocks to form a chain, which makes the data in the block have the characteristics of immutability, traceability, and publicity. Furthermore, the blockchain generates, updates, and stores data through a consensus algorithm, which achieves decentralization. It declares and transfers digital assets through digital signature to ensure the security of data transmission and access.

In the blockchain, since the content of each block is unpredictable, the hash value of the next block is unpredictable. Taking Ethereum blockchain as an example, the data in Ethereum is public and verifiable. Anyone can access Ethereum to query the content of the blockchain and verify the hash values of blocks. Currently, the computing power of Ethereum is 449.1 TH/s, i.e., 4.49×10¹⁴ hash operates per second. Compared with Ethereum, the sustained performance of Sunway TaihuLight, the fastest supercomputer in China, is 9.3×10¹⁶ logical operations per second which is about 5.5×10¹² hash operations per second. Obviously, the computing power of Ethereum is higher than that of Sunway TaihuLight. Thus, Ethereum has sufficient computing power to ensure the unforgeability of data.

### SUMMARY

The technical problem to be solved by the disclosure is to provide a blockchain-based public parameter generation method against backdoor attacks according to the excellent properties of blockchains, such as openness and transparency, tamper-proof, and randomness of the hash values of the latest confirmed blocks.

The technical solution adopted by the disclosure for the technical problem to be solved is a blockchain-based public parameter generation method against backdoor attacks, the method comprising the following steps:

1) Preparation Phase:

determining the range and conditions of parameters, and generating a set G of public parameters;

2) Generation Phase of Public Parameters:

setting a generation count variable i and the number of consecutive blocks L;

acquiring the hash values of the latest confirmed L blocks on a blockchain, and mapping the hash values of the L blocks and the generation count variable i to an element in the set G via a specified mapping to obtain the generated public parameter; L≥φ, φ is the minimum number to ensure blockchains' chain quality property;

3) Verification Phase of Public Parameters:

checking whether the parameter generated in the generation phase meets the condition; if not, discarding the parameter, updating the generation count variable i=i+1, and returning to 2); if the condition is met, outputting the public parameter to the device that uses the public parameter.

The benefits of the disclosure are as follows:

The public parameters are random, since they are based on the latest confirmed blocks on the blockchain and are guaranteed by the computational power of the blockchain; the generation of public parameters is publicly verifiable and random, and with high security and decentralization, which can effectively resist backdoor attacks.

The disclosure is verifiable since it is completely transparent to users and anyone can calculate the public parameter based on the corresponding block hash values.

The disclosure is decentralized and without any investment from a third party.

### BRIEF DESCRIPTION OF THE DRAWINGS

FIG. 1 shows a schematic diagram that mapping the hash values of L-successive blocks that are latest confirmed on the blockchain to generate the public parameter; and

FIG. 2 is a flow chart of a public parameter generation method against backdoor attacks of the disclosure.

### DETAILED DESCRIPTION

To further illustrate, embodiments detailing a public parameter generation method against backdoor attacks are described below. It should be noted that the following embodiments are intended to describe and not to limit the disclosure.

The example chooses Zₚ, an additive group of remainder of module p, as the set G to discuss, where p is a big prime. The public parameter generation methods of other sets are similar to that of Zₚ, this paper will not describe them in detail.

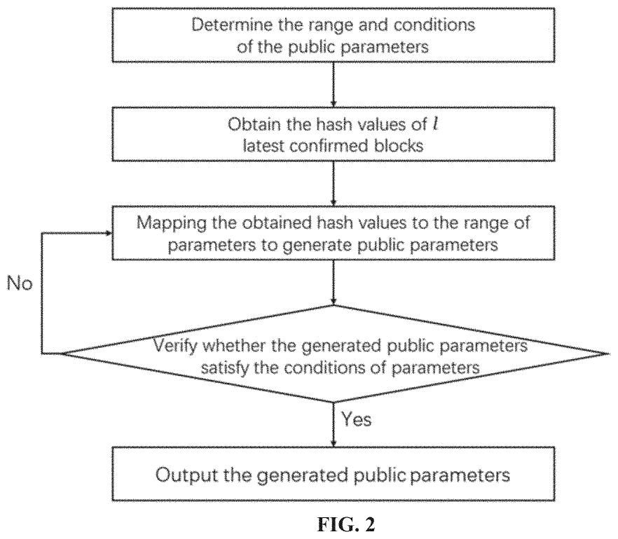

The generation process of public parameters is shown in FIG. 2:

1) Preparation Phase:

First, determine the range and conditions of parameters. The public parameter generation rule in Zₚ: given a big prime p, determine a group Zₚ={0, 1, 2, . . . , p−1}. Determine the condition of the parameter Parameter to be 1<Parameter<p−1, or other conditions that satisfy specifications. Determine the parameter set G=Zₚ.

2) Generation Phase:

At the beginning of generating the public parameter, set i=0 initially. Then, the hash values of the L blocks latest confirmed on the blockchain are used as part of inputs. Denote the hash values of the L blocks latest confirmed on the blockchain by HBlock1, HBlock2, . . . , HBlockL respectively in chronological order. L≥φ, φ is the minimum number to guarantee blockchains' chain quality property. When the public parameter is generated based on the Ethereum blockchain, the minimum number φ to guarantee blockchains' chain quality property is 12; When the public parameter is generated based on the Bitcoin blockchain, the minimum number φ to guarantee blockchains' chain quality property is 6. Recently, the minimum number φ for ensuring blockchains' chain quality property is well defined.

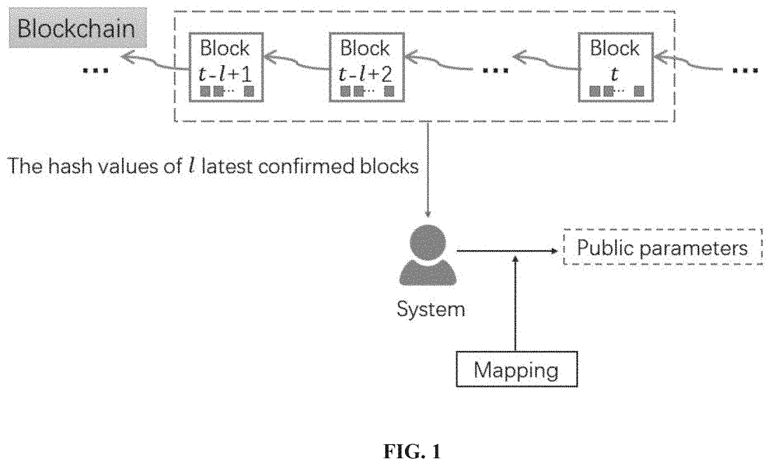

This disclosure defines a mapping f(HBlock1, HBlock2, . . . , HBlockL, i)→G, i=0, 1, . . . . The mapping maps hash values of L blocks to an element in set G. As shown in FIG. 1, the example maps hash values of L blocks to an element in set Zₚ by utilizing hash mappings. If the SHA256 algorithm is employed as the hash function, then the hash function maps a binary value of any length to a binary value of 256-bit, i.e., H:{0,1}*→{0,1}²⁵⁶. Define a mapping H(HBlock1, HBlock2, . . . , HBlockL∥i)→Zₚ, i=0, 1, . . . , where ∥ denotes concatenation and H(⋅) is a hash function, which maps a binary value of any length to a binary value of fixed length that is called hash value. Generate a=H(HBlock1∥HBlock2∥ . . . ∥HBlockL∥i).

Furthermore, in order to ensure the randomness and the uniform distribution of the generated public parameters in the set Zₚ, according to the size comparison between the length pLen of a given parameter in set G and the length of output of hash function (e.g., 256 for SHA256), adopting two different strategies to compute the public parameter. If pLen≤256, the public parameter a=H(HBlock1∥HBlock2∥ . . . ∥HBlockL∥i) mod p, where mod denotes modulo operation, then the generated parameter a₁∈Zₚ is obtained; if pLen>256, first computing the minimum l satisfying pLen≤256×l, (i.e.,

$$l = ⌈ \frac{p L e n}{256} ⌉$$

denoting the smallest integer larger than

$$\frac{p L e n}{256} ) ,$$

then computing the public parameter a=H(HBlock1∥HBlock2∥ . . . ∥HBlockL∥i)∥H(HBlock1∥HBlock2∥ . . . ∥HBlockL∥i+1)∥ . . . ∥H(HBlock1∥HBlock2∥ . . . ∥HBlockL∥i+l−1) mod p, i=0. The public parameter a E Zₚ is obtained.

3) Verification Phase:

Check whether a meets the condition that 1<a<p−1. if so, output the public parameter Parameter=a; otherwise, return to the generation phase with i=i+1 to get a=H(HBlock1∥HBlock2∥ . . . ∥HBlockL∥i) E Zₚ or a=H(HBlock1∥HBlock2∥ . . . ∥HBlockL∥i)∥H(HBlock1∥HBlock2∥ . . . ∥HBlockL∥i+1)∥ . . . ∥H(HBlock1∥HBlock2∥ . . . ∥HBlockL∥i+l−1) mod p, i=0. Repeat this step until the generated parameter satisfies the condition of the public parameter.

Next, we will give several typical backdoor attacks and the corresponding public parameter generation methods.

### Example 1

1.1 Subverted RSA Key Generation

The correct generation of RSA public key is as follows. (1) Arbitrarily select two different large prime numbers p and q to calculate their product N=pq. Calculate φ(N)=(p−1)(q−1). (2) Arbitrarily select a big integer e that is relatively prime to φ(N): gcd(e, φ(n))=1, where gcd denotes the greatest common factor of two numbers. (3) Calculate d that satisfies ed=1 mod φ(N). The public key is (N, e) and the secret key is d.

The generation of RSA public key with the backdoor attack is described as follows: (1) Arbitrarily choose two different large prime numbers p and q to calculate their product N=pq. Calculate φ(N)=(p−1)(q−1). (2) Leveraging its public key pk* to encrypt p and obtains e₁, i.e., e₁=Enc(pk*,p). Then construct e=e₁∥e₂ which satisfying gcd(e, φ(N))=1, where e₂ is randomly chosen. (3) Calculate d that satisfies ed=1 mod φ(N). The public key is (N, e) and the secret key is d.

In the subverted RSA key generation, the public key with a backdoor is computationally indistinguishable to the correctly generated one. An attacker knowing the backdoor can launch an attack in an undetectable fashion. Specifically, He first recovers the secret parameter p with the private key sk*, which is corresponding to pk*, then solve q and φ(N). Next, the attacker computes users' private key d with the help of e and φ(N). At last, the security is compromised. By contrast, the generation method of e in this disclosure can circumvent the compromise of d. The specific way is described in 1.2.

1.2 Blockchain-Based RSA Public Key Generation Method Against Backdoor Attacks

Preparation:

Determine the range of RSA public key e: the set G={0,12, . . . , φ(n)−1}, where φ(N) is the given parameter in set G. Determine the condition of RSA public key e: e and φ(n) are relatively prime, i.e., gcd(e, φ(n))=1. The generation method of public key e in RSA algorithm against backdoor attacks and the corresponding pseudocode are given below.

The generation method of public key e in RSA algorithm against
backdoor attacks

Input: φ(n)
Output: e

| | |
|---|---|
| 1: | i ← 0 |
| 2: | do |
| 3: | HBlock1, ··· HBlock12 ← the hash values of the 12 latest |

confirmed blocks on Ethereum

| | |
|---|---|
| 4: | Len ← the bit length of φ(n) |
| 5: | if Len ≤ 256 |
| 6: | α ← H(HBlock1 ∥ ··· ∥ HBlock12 ∥ i) mod φ(n) |
| 7: | else |
| 8: | $l ← ⌈ \frac{Len}{256} ⌉$ |
| 9: | α ← H(HBlock1 ∥ ··· ∥ HBlock12 ∥ i) ∥ H(HBlock1 ∥ ··· |
| | ∥ HBlock12 ∥ |
| i + | 1) ∥ ··· ∥ H(HBlock1 ∥ ··· ∥ HBlock12 ∥ i + l − |

1) mod φ(n)

| | |
|---|---|
| 10: | i ← i + 1 |
| 11: | until gcd(a, φ(n)) = 1 |
| 12: | e ← a |
| 10: | return e |

Generation Phase:

At the beginning of generating the public parameter, set i=0 initially. Then, the hash values of the 12 blocks latest confirmed on Ethereum are used as part of the input. Let the hash values of the 12 blocks latest confirmed on Ethereum be Hblock1, HBlock2, . . . , HBlock12 respectively in chronological order.

Define a mapping f(HBlock1, HBlock2, . . . , HBlock12,i)→G, i=0, 1, . . . , where ∥ denotes concatenation and H(⋅) is a hash function, which maps a binary value of any length to a binary value of fixed length that is called hash value. In this example, if the SHA256 algorithm is employed as the hash function, i.e., H:{0,1}*→{0,1}²⁵⁶, then the hash function maps a binary value of any length to a binary value of 256-bit.

Concretely, first compute the bit length of φ(n) denoted by Len. If Len≤256, a=H(HBlock1∥HBlock2∥ . . . ∥HBlock12∥i) mod φ(N), where mod denotes modular operation, then the generated parameter a E G is obtained; if Len>256, first computing the minimum l satisfying Len≤256l (i.e.,

$$l = ⌈ \frac{L e n}{256} ⌉$$

denoting the smallest integer larger than

$$\frac{L e n}{256} ) ,$$

then computing a=H(HBlock1∥HBlock2∥ . . . ∥HBlock12∥i)∥H(HBlock1∥HBlock2∥ . . . ∥HBlock12∥i+1)∥ . . . ∥H(HBlock1∥HBlock2∥ . . . ∥HBlock12∥i+l−1) mod φ(N), i=0. The public parameter a E G is obtained.

Verification Phase:

Verify whether a satisfies gcd(a, φ(n))=1. If so, output the public parameter e=a, so that the public key of RSA is (N, e). Otherwise, re-execute the generation phase with the updated i=i+1. Repeat this step until the parameter satisfying the condition is found.

### Example 2

2.1 (i′,i′+1) DH Kleptogram

The attack process of (i′,′+1) DH Kleptogram is below:

The honest protocol generates the secret key g^{a}^{_{i′}} from a_{i′}=H(h^{a}^{_{i′−1}}) each time, where g and h are two generator of the cyclic group, and is the count variable for generation. Note that all operations are in the group. However, if a backdoor is embedded, i.e., h=gβ, any entity owning β is able to derive a_{i′+1} from g^{a}^{_{i′}}, i.e., a_{i′+1}=H(h^{a}^{_{i′}})=H((g^{β})^{a}^{_{i′}})=H((g^{a}^{_{i′}})^{β}).

2.2 Blockchain-Based Parameter Generation Method Against (i′,′+1) DH Kleptogram

Preparation:

Determine the range of the public parameter g: the group Zₚ={0, 1, 2, . . . , p−1}, where p is a big prime. Determine the condition of the public parameter g: g is the generator of Zₚ, and its order is p−1, i.e., ord(g)=p−1, where ord(⋅) is the order of the corresponding element in the group. The generation method of public parameter g against backdoor attacks and the corresponding pseudocode are given below.

The generation method of public parameter g against backdoor attacks

Input: p
Output: g

| | |
|---|---|
| 1: | i ← 0 |
| 2: | do |
| 3: | HBlock1, ··· HBlock12 ← the hash values of the 12 latest |

confirmed blocks on Ethereum

| | |
|---|---|
| 4: | pLen ← the bit length of p |
| 5: | if pLen ≤ 256 |
| 6: | α ← H(HBlock1 ∥ ··· ∥ HBlock12 ∥ i) mod p |
| 7: | else |
| 8: | $l ← ⌈ \frac{pLen}{256} ⌉$ |
| 9: | α ← H(HBlock1 ∥ ··· ∥ HBlock12 ∥ i) ∥ H(HBlock1 ∥ ··· |
| | ∥ HBlock12 ∥ |
| i + | 1) ∥ ··· ∥ H(HBlock1 ∥ ··· ∥ HBlock12 ∥ i + l − |

1) mod p

| | |
|---|---|
| 10: | i ← i + 1 |
| 11: | until ord(g) = p − 1 |
| 12: | g ← a |

Generation Phase:

At the beginning of generating the public parameter, set i=0 initially. Then, the hash values of the 12 blocks latest confirmed on Ethereum are used as part of the input. Let the hash values of the 12 blocks latest confirmed on Ethereum be Hblock1, HBlock2, . . . , HBlock12 respectively in chronological order.

Define a mapping H(HBlock1, HBlock2, . . . , HBlock12, i)→Zₚ, i=0, 1, . . . , where ∥ denotes concatenation and H(⋅) is a hash function, which maps a binary value of any length to a binary value of fixed length that is called hash value. In this example, if the SHA256 algorithm is employed as the hash function, i.e., H: {0,1}*→{0,1}²⁵⁶, then the hash function maps a binary value of any length to a binary value of 256-bit.

Specifically, first compute the bit length of p denoted by pLen. If pLen≤256, a=H(HBlock1∥HBlock2∥ . . . ∥HBlock12∥i) mod p, where mod denotes modular operation, then the generated parameter a∈Zₚ is obtained; if pLen>256, first computing the minimum l satisfying pLen≤256l (i.e.,

$$l = ⌈ \frac{p L e n}{256} ⌉$$

denoting the smallest integer larger than

$$\frac{p L e n}{256} ) ,$$

then computing a=H(HBlock1∥HBlock2∥ . . . ∥HBlock12∥i)∥H(HBlock1∥HBlock2∥ . . . ∥HBlock12∥i+1)∥ . . . ∥H(HBlock1∥HBlock2∥ . . . ∥HBlock12∥i+l−1) mod p, i=0. The public parameter a∈Zₚ is obtained. The above method ensures that the generated public parameters are uniformly distributed in the set and achieves the randomness.

Verification Phase:

Verify whether a satisfies ord(a)=p−1. If so, output the public parameter g=a. Otherwise, re-execute the generation phase with the updated i=i+1. Repeat this step until the parameter satisfying the condition is found.

### Example 3

3.1 Backdoor Attacks on E-voting System sVote

Haines et al. show there is a vulnerability in the Swiss e-voting system called sVote, in which the prime numbers corresponding to voting options can be embedded backdoors. For example, consider the case that clients collude with servers, there are two options correspond to two different primes p_{yes} and pₙₒ, respectively. Assume that a voter would like to submit p_{yes}, the malicious client and the cheating server will modify the voter's choice from p_{yes} to pₙₒ in a way that is completely undetectable. Specifically, the client generates the partial choice code of pₙₒ. Then, the server leverages the received partial choice codes to construct the choice code for the voter to verify. Note that the verification content corresponding to the modified option now is pₙₒ^{k}, where k is a key to retrieve the choice code. Since the server knows the parameters embedded backdoors in advance, such as a and b satisfying p_{yes}^{a}=pₙₒ^{b} mod p, the return code p_{yes}^{k} that the server sends to the voter can be derivate from pₙₒ^{k}, i.e., p_{yes}^{k}=(pₙₒ^{b/a})^{k}=(pₙₒ^{k})^{b/a} mod p. Consequently, the voter is deceived.

3.2 Blockchain-Based E-Voting Parameter Generation Method Against Backdoor Attacks

Preparation:

Determine the range of the public parameter p_{yes}: the set of positive integers Z⁺. Determine the condition of the public parameter p_{yes}: p_{yes} is a prime. The generation method of e-voting public parameter p_{yes} against backdoor attacks and the corresponding pseudocode are given below.

The generation method of e-voting public
parameter p_{yes} against backdoor attacks

Input: ⊥
Output: p_{yes}
1: i ← 0
2: do
3: HBlock1, ^{...} HBlock12 ← the hash values of the 12
latest confirmed blocks on Ethereum
4: α ← H(HBlock1 || ^{...} || HBlock12 || i)
5: i ← i + 1
6: until p_{yes} is a prime
7: p_{yes} ← α

Generation Phase:

At the beginning of generating the public parameter, set i=0 initially. Then, the hash values of the 12 blocks latest confirmed on Ethereum are used as part of the input. Let the hash values of the 12 blocks latest confirmed on Ethereum be Hblock1, HBlock2, . . . , HBlock12 respectively in chronological order.

Define a mapping H(HBlock1, HBlock2, . . . , HBlock12, i)→Z⁺,i=0, 1, . . . , where ∥ denotes concatenation and H(⋅) is a hash function, which maps a binary value of any length to a binary value of fixed length that is called hash value. In this example, if the SHA256 algorithm is employed as the hash function, i.e., H: {0,1}*→{0,1}²⁵⁶, then the hash function maps a binary value of any length to a binary value of 256-bit.

Compute a=H(HBlock1∥HBlock2∥ . . . ∥HBlock12∥i), and the generated parameter a∈Z⁺ is obtained.

Verification Phase:

Verify whether a satisfies the condition of primality. If so, output the public parameter p_{yes}=a. Otherwise, return to the generation phase and compute a=H(HBlock1∥HBlock2∥ . . . ∥HBlock12∥i) with the updated i=i+1. Repeat this step until the parameter satisfying the condition is found.

Black-box cryptographic devices suffer from backdoor attacks. The attacker may embed the backdoor into the device stealthily: the secret key of users is embedded into public parameters output by devices, and then can be recovered from public parameters. To resist backdoor attack, this disclosure proposes a blockchain-based public parameter generation method against backdoor attacks, and describes the method in detail. In this paper, specific examples are applied to explain the principle and implementation of the disclosure. The examples are useful for understanding the method and the key idea of the disclosure. Note that for ordinary technicians in the technical field, on the premise of not departing from the principle of the disclosure, a mass of improvements and modifications can be made to the disclosure. The improvements and modifications fall within the protection scope of the claims of the disclosure.

It will be obvious to those skilled in the art that changes and modifications may be made, and therefore, the aim in the appended claims is to cover all such changes and modifications.

What is claimed is:

1. A blockchain-based public parameter generation method against backdoor attacks, the method comprising:
1) preparation phase:
determining a range and conditions of public parameters, and generating a set G of the public parameters;
2) generation phase of the public parameters:
setting a generation count variable i and a number of consecutive blocks L; acquiring hash values of latest confirmed L blocks on a blockchain, and mapping the hash values of the L blocks and the generation count variable i to an element in the set G via a specified mapping to obtain the generated public parameter; L≥φ, φ is a minimum number to ensure blockchains' chain quality property; and
3) verification phase of the public parameters:
checking whether the public parameter generated in the generation phase meets a condition; if not, discarding the parameter, updating the generation count variable i=i+1, and returning to 2); if the condition is met, outputting the public parameter to a device that uses the public parameters.

2. The method of claim 1, wherein in 2), the specific method that acquires the hash values of the latest confirmed L blocks on a blockchain and maps the hash values of the L blocks and the generation count variable i to an element in the set G via the specified mapping to obtain the generated public parameter is as follows:
denoting the hash values of the latest confirmed L blocks on the blockchain, respectively, by HBlock1, HBlock2, . . . , HBlockL in chronological order; denoting the specified mapping by f, and mapping the hash values of the L blocks and the generation count variable i to an element in the set G via the specified mapping, f(HBlock1, HBlock2, . . . , HBlockL, i)→G; and generating the public parameter a=f(HBlock1, HBlock2, . . . , HBlockL, i).

3. The method of claim 1, wherein in 2), the specific method that acquires the hash values of the latest confirmed L blocks on a blockchain and maps the hash values of the L blocks and the generation count variable i to an element in the set G via the specified mapping to obtain the generated public parameter is as follows:
according to a size comparison between a length pLen of a given parameter p in set G and a length k of output of hash function H: {0,1}*→{0,1}^{k}, using two different strategies to compute the public parameter; if pLen≤k, computing the public parameter a=H(HBlock1∥HBlock2∥ . . . ∥HBlockL∥i) mod p, where mod denotes modulo operation; if pLen>k, first computing the minimum l satisfying pLen≤k×l, then computing the public parameter a=H(HBlock1∥HBlock2∥ . . . ∥HBlockL∥i)∥H(HBlock1∥HBlock2∥ . . . ∥HBlockL∥i+1)∥ . . . ∥H(HBlock1∥HBlock2∥ . . . ∥HBlockL∥i+l−1)mod p, i=0.

4. The method of claim 1, wherein
in 2), when the public parameter based on the Ethereum blockchain is generated, the minimum number φ to guarantee blockchains' chain quality property is 12; and
in 2) when the public parameter based on the Bitcoin blockchain is generated, the minimum number φ to guarantee blockchains' chain quality property is 6.

5. The method of claim 2, wherein
in 2), when the public parameter based on the Ethereum blockchain is generated, the minimum number φ to guarantee blockchains' chain quality property is 12; and
in 2) when the public parameter based on the Bitcoin blockchain is generated, the minimum number φ to guarantee blockchains' chain quality property is 6.

6. The method of claim 3, wherein
in 2), when the public parameter based on the Ethereum blockchain is generated, the minimum number φ to guarantee blockchains' chain quality property is 12; and
in 2) when the public parameter based on the Bitcoin blockchain is generated, the minimum number φ to guarantee blockchains' chain quality property is 6.

7. The method of claim 2, wherein L=12.

8. The method of claim 3, wherein L=12.
